(19) United States
(12) Patent Application Publication
(10) Pub. No.: US 2025/0047170 A1
(43) Pub. Date: Feb. 6, 2025

(54) TWELVE-STEP DYNAMIC COMMUTATION FOR AN ELECTRIC MOTOR

(71) Applicant: MILWAUKEE ELECTRIC TOOL CORPORATION, Brookfield, WI (US)

(72) Inventors: Alexander T. Huber, Menomonee Falls, WI (US); Gerald M. Nagel, Sussex, WI (US); Shuvam Gupta, Wauwatosa, WI (US); Robert D. Turney, Watertown, WI (US)

(21) Appl. No.: 18/715,198

(22) PCT Filed: Dec. 7, 2022
(86) PCT No.: PCT/US2022/081055

§ 371 Date: May 31, 2024

Related U.S. Application Data
(60) Provisional application No. 63/287,800, filed on Dec. 9, 2021.

(51) Int. Cl. H02K 11/00; H02K 11/21; H02P 6/06; H02P 6/16; H02P 25/03

(52) U.S. Cl. CPC H02K 11/0094; H02K 11/21; H02P 6/06; H02P 6/16; H02P 25/03

(57) ABSTRACT

A power tool includes a motor, a switching module, a plurality of rotor position sensors, and a controller. The switching module includes a plurality of high-side switches and a plurality of low-side switches. The rotor position sensors are configured to output signals related to the position of the rotor. The controller is configured to drive the motor using a twelve-step commutation sequence. A first step includes one of the plurality of high-side switches and one of the plurality of low-side switches turned to an ON conduction state. The controller is configured to calculate an updated phase transition angle for the twelve-step commutation sequence, and drive the motor using the twelve-step commutation sequence based on the updated phase transition angle. A second step following a phase transition includes either two of the plurality of high-side switches or two of the plurality of low-side switches turned to the ON conduction state.

### RELATED APPLICATIONS

This application claims the benefit of U.S. Provisional Patent Application No. 63/287,800, filed Dec. 9, 2021, the entire content of which is hereby incorporated by reference.

### FIELD

Embodiments described herein relate to electric power tools.

### SUMMARY

Power tools described herein include a brushless direct current (“BLDC”) motor, a switching module, a plurality of rotor position sensors, and a controller. The switching module includes a plurality of high-side switches and a plurality of low-side switches, and is configured to drive the BLDC motor. The plurality of rotor position sensors are configured to output signals related to the position of the rotor. The controller configured to drive the motor using a twelve-step commutation sequence. A first step of the twelve-step commutation sequence includes one of the plurality of high-side switches and one of the plurality of low-side switches turned to an ON conduction state. The controller is configured to receive the output signals from the plurality of rotor position sensors, calculate an updated phase transition angle for the twelve-step commutation sequence based on the output signals, and drive the motor using the twelve-step commutation sequence based on the updated phase transition angle. A second step of the twelve-step commutation sequence following a phase transition includes either two of the plurality of high-side switches or two of the plurality of low-side switches turned to the ON conduction state.

In some aspects, the switching module includes three high-side switches and three low-side switches.

In some aspects, the controller is further configured to calculate a second updated phase transition angle for the twelve-step commutation sequence based on the output signals.

In some aspects, the controller is further configured to drive the motor using the twelve-step commutation sequence based on the second updated phase transition angle.

In some aspects, a third step of the twelve-step commutation sequence following a second phase transition including one of the plurality of high-side switches and one of the plurality of low-side switches turned to the ON conduction state.

In some aspects, the controller is further configured to calculate a third updated phase transition angle for the twelve-step commutation sequence based on the output signals.

In some aspects, the controller is further configured to drive the motor using the twelve-step commutation sequence based on the third updated phase transition angle.

In some aspects, the controller is further configured to calculate a delay variable based on the updated phase transition angle.

In some aspects, the controller is further configured to set the delay variable in response to driving the motor using the twelve-step commutation sequence based on the updated phase transition angle.

Power tools described herein include a brushless direct current (“BLDC”) motor, a multi-level switching module, a plurality of rotor position sensors, and a controller. The multi-level switching module includes a first set of switches and a second set of switches. Each of the first set of switches and the second set of switches includes a plurality of high-side switches and a plurality of low-side switches. The switching module is configured to drive the BLDC motor. The plurality of rotor position sensors is configured to output signals related to the position of the rotor. The controller is configured to drive the motor using a twelve-step commutation sequence. A first step of the twelve-step commutation sequence includes each of the plurality of high-side switches in the first set of switches being turned to an ON conduction state. The controller is further configured to receive the output signals from the plurality of rotor position sensors, calculate an updated phase transition angle for the twelve-step commutation sequence based on the output signals, and drive the motor using the twelve-step commutation sequence based on the updated phase transition angle. A second step of the twelve-step commutation sequence following a phase transition includes each of the plurality of high-side switches in the first set of switches being turned to an ON conduction state and at least one of the plurality of high-side switches in the second set of switches turned to an ON conduction state.

In some aspects, the multi-level switching module is a flying capacitor multi-level (“FCML”) inverter.

In some aspects, the FCML inverter is a three-level FCML inverter.

In some aspects, the controller is further configured to calculate a second updated phase transition angle for the twelve-step commutation sequence based on the output signals.

In some aspects, the controller is further configured to drive the motor using the twelve-step commutation sequence based on the second updated phase transition angle.

In some aspects, the controller is further configured to calculate a delay variable based on the updated phase transition angle.

In some aspects, the controller is further configured to set the delay variable in response to driving the motor using the twelve-step commutation sequence based on the updated phase transition angle.

Methods described herein for controlling a power tool including a controller include driving a motor using a twelve-step commutation sequence. A first step of the twelve-step commutation sequence includes one of a plurality of high-side switches and one of a plurality of low-side switches turned to an ON conduction state. The methods further include receiving output signals from a plurality of rotor position sensors, calculating an updated phase transition angle for the twelve-step commutation sequence based on the output signals, and driving the motor using the twelve-step commutation sequence based on the updated phase transition angle. A second step of the twelve-step commutation sequence following a phase transition includes either two of the plurality of high-side switches or two of the plurality of low-side switches being turned to the ON conduction state.

In some aspects, the method further includes calculating a second updated phase transition angle for the twelve-step commutation sequence based on the output signals.

In some aspects, the method further includes driving the motor using the twelve-step commutation sequence based on the second updated phase transition angle.

In some aspects, the method further includes calculating a delay variable based on the updated phase transition angle, and setting the delay variable in response to driving the motor using the twelve-step commutation sequence based on the updated phase transition angle.

Methods described herein for controlling a power tool including a controller include driving a motor using a twelve-step commutation sequence. A first step of the twelve-step commutation sequence includes each of a plurality of high-side switches in a first set of switches turned to an ON conduction state. The methods also include receiving output signals from a plurality of rotor position sensors, calculating an updated phase transition angle for the twelve-step commutation sequence based on the output signals, and driving the motor using the twelve-step commutation sequence based on the updated phase transition angle. A second step of the twelve-step commutation sequence following a phase transition includes each of the plurality of high-side switches in the first set of switches being turned to an ON conduction state and at least one of a plurality of high-side switches in a second set of switches being turned to an ON conduction state.

In some aspects, the first set of switches and the second set of switches are included in a multi-level switching module, and the multi-level switching module is a flying capacitor multi-level (“FCML”) inverter.

In some aspects, the FCML inverter is a three-level FCML inverter.

In some aspects, the method further includes calculating a second updated phase transition angle for the twelve-step commutation sequence based on the output signals.

In some aspects, the method further includes driving the motor using the twelve-step commutation sequence based on the second updated phase transition angle.

In some aspects, the method further includes calculating a delay variable based on the updated phase transition angle.

In some aspects, the method further includes setting the delay variable in response to driving the motor using the twelve-step commutation sequence based on the updated phase transition angle.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 is a perspective view of a hand-held power tool, according to an embodiment of the disclosure.

FIG. 2 is a perspective view of a battery pack, according to an embodiment of the disclosure.

FIG. 3 illustrates a control system for the hand-held power tool of FIG. 1, according to embodiments described herein.

FIG. 4 illustrates a control block diagram for the hand-held power tool of FIG. 1, according to embodiments described herein.

FIG. 5 is a side view of a motor for use in the hand-held power tool of FIG. 1, according to an embodiment of the disclosure.

FIG. 6A illustrates a switching bridge for operation of the motor of FIG. 5, according to an embodiment of the disclosure.

FIG. 6B illustrates a switching bridge for operation of the motor of FIG. 5, according to an embodiment of the disclosure.

FIG. 6C illustrates a switching bridge for operation of the motor of FIG. 5, according to an embodiment of the disclosure.

FIG. 6D illustrates a switching bridge for operation of the motor of FIG. 5, according to an embodiment of the disclosure.

FIG. 7 illustrates a brushed motor configuration, according to an embodiment of the disclosure.

FIG. 8 is a flowchart showing how to set a phase angle for operation of the hand-held power tool of FIG. 1, according to an embodiment of the disclosure.

FIG. 9 is a flowchart showing how to set a commutation angle for operation of the hand-held power tool of FIG. 1, according to an embodiment of the disclosure.

FIG. 10 is a flowchart showing how to update a commutation of a motor for the hand-held power tool of FIG. 1, according to an embodiment of the disclosure.

FIG. 11 is a flowchart showing dynamic hall transitions for operation of the hand-held power tool of FIG. 1, according to an embodiment of the disclosure.

FIG. 12 is a flowchart showing dynamic commutation for operation of the hand-held power tool of FIG. 1, according to an embodiment of the disclosure.

FIG. 13A is a flowchart showing commutation for operation of the hand-held power tool of FIG. 1, according to an embodiment of the disclosure.

FIG. 13B is a waveform showing commutation for operation of the hand-held power tool of FIG. 1, according to an embodiment of the disclosure.

FIG. 13C is a table showing commutation for operation of the hand-held power tool of FIG. 1, according to an embodiment of the disclosure.

FIG. 14 is a flowchart illustrating a process for completing a commutation sector for operation of the hand-held power tool of FIG. 1, according to an embodiment of the disclosure.

FIG. 15 is a graph showing operation of the hand-held power tool of FIG. 1, according to an embodiment of the disclosure.

FIG. 16 is a graph showing operation of the hand-held power tool of FIG. 1, according to an embodiment of the disclosure.

FIG. 17 is a waveform diagram showing commutation operation of the hand-held power tool of FIG. 1, according to an embodiment of the disclosure.

FIG. 18 is a waveform diagram showing commutation operation of the hand-held power tool of FIG. 1, according to an embodiment of the disclosure.

### DETAILED DESCRIPTION

Embodiments described herein relate to a power tool (e.g., a hand-held power tool) that includes a brushless or electronically commutated motor (e.g., a brushless direct current [“BLDC” ] motor), a switching array, and a controller. The controller is configured to selectively control the switching of the switches within the switching array to implement a dynamic twelve-step commutation mode or scheme for the BLDC motor. The dynamic twelve-step commutation mode provides, for example, a system and method in which the BLDC motor can be run at higher speed and low torque conditions. This is accomplished through shaping the electromagnetics between the rotor field and stator field within the BLDC motor by switching logic which shifts in time with respect to position and Hall effect sensor transitions. By weakening or strengthening the field relative to position, different speed and torque conditions are realized. The controller is further configured to control the BLDC motor based on one or more characteristics of the motor or power tool (e.g., motor speed, trigger pull, motor current draw, etc.). Additionally, once the power tool motor is being driven in the dynamic twelve-step commutation mode, the light to medium application speeds of the power tool is boosted at merely the cost of a higher current draw. The brushless motor systems, devices, and control methods are described below with respect to a variety of power tools.

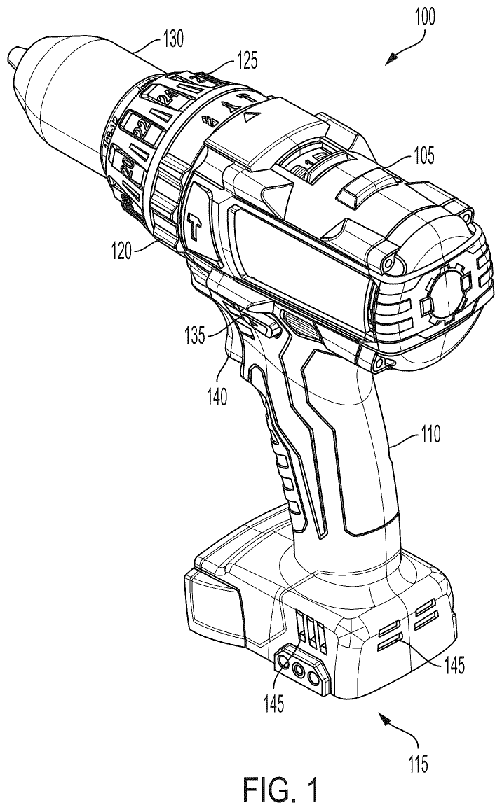

FIG. 1 illustrates an example power tool (e.g., a hand-held power tool) that includes a brushless motor (e.g., a BLDC motor). The hand-held power tool illustrated in FIG. 1 is a hammer drill/driver (“hammer drill”) 100. The hammer drill 100 includes an upper main body 105, a handle portion 110, a battery pack receiving portion 115, a mode selection portion 120 (e.g., for selecting among a drilling mode, a driving mode, a hammer mode, etc.), a torque adjustment dial or ring 125, an output drive device or mechanism (e.g., a chuck) 130, a forward/reverse selection button 135, a trigger 140, and air vents 145. In some embodiments, the hammer drill 100 also includes a work light, and the battery pack receiving portion 115 receives a battery pack and includes a plurality of terminals.

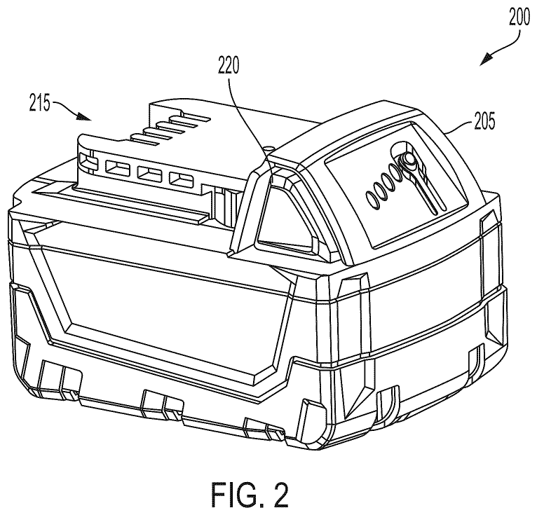

The number of terminals present in the receiving portion 115 of the power tool 100 can vary based on the type of power tool. However, as an illustrative example, the receiving portion can include a battery positive (“B+”) terminal, a battery negative (“B−”) terminal, a sense or communication terminal, an identification terminal, etc. The battery positive and battery negative terminals are operable to electrically connect the battery pack to the hand-held power tool 100 and provide operational power (i.e., voltage and current) for the hand-held power tool 100 from a battery pack 200 (see FIG. 2) coupled to the hand-held power tool 100. The sensor or communication terminal is operable to provide communication or sensing for the hand-held power tool 100 of the battery pack 200. For example, the communication can include serial communication or a serial communication link, the transmission or conveyance of information from one of the battery pack or the hand-held power tool 100 to the other of the battery pack 200 or hand-held power tool 100 related to a condition or characteristic of the battery pack 200 or hand-held power tool 100 (e.g., one or more battery cell voltages, one or more battery pack voltages, one or more battery cell temperatures, one or more battery pack temperatures, etc.). The identification terminal can be used by the battery pack 200 or the hand-held power tool 100 to identify the other of the battery pack 200 or the hand-held power tool 100.

The hand-held power tool 100 described above receives power (i.e., voltage and current) from a battery pack, such as the battery pack 200 illustrated in FIG. 2. The battery pack 200 is connectable to and supportable by the power tool 100. The battery pack 200 includes a housing 205 and at least one rechargeable battery cell supported by the housing 205. The battery pack 200 also includes a support portion 215 for supporting the battery pack 200 on and coupling the battery pack 200 to a power tool, a coupling mechanism 220 for selectively coupling the battery pack 200 to, or releasing the battery pack 200 from, a power tool. In the illustrated embodiment, the support portion 215 is connectable to a complementary support portion on the power tool (e.g., the battery pack receiving portion 115).

The battery pack 200 includes a plurality of terminals and electrical connectors operable to electrically connect the power tool to, for example, the battery cells or a printed circuit board (“PCB”) within the battery pack 200. The plurality of terminals includes, for example, a positive battery terminal, a ground terminal, and a sense terminal. The battery pack 200 is removably and interchangeably connected to a power tool 100 to provide operational power to the power tool 100. The terminals are configured to mate with corresponding terminals of the power tool 100 (e.g., within the battery pack receiving portions 115). The battery pack 200 substantially encloses and covers the terminals on the power tool when the pack 200 is positioned within the battery pack receiving portions 115. That is, the battery pack 200 functions as a cover for the opening and terminals of the power tool 100. Once the battery pack 200 is disconnected from the power tool 100, the terminals on the power tool 100 are generally exposed to the surrounding environment. In this illustrated embodiment, the battery pack 200 is designed to substantially follow the contours of the power tool 100 to match the general shape of the outer casing of the handle of the power tool 100, and the battery pack 200 generally increases (e.g., extends) the length of a grippable portion of the tool (i.e., a portion of the tool below the tool 100 main body).

In some embodiments, the battery pack 200 includes 10 battery cells. In other embodiments, the battery pack 200 can include more or fewer battery cells. The battery cells can be arranged in series, parallel, or a series-parallel combination. For example, the battery pack can include a total of 10 battery cells configured in a series-parallel arrangement of five sets of two parallel-connected cells. The series-parallel combination of battery cells allows for an increased voltage and an increased capacity of the battery pack. In some embodiments, the battery pack 200 includes five series-connected battery cells. In other embodiments, the battery pack 200 includes a different number of battery cells (e.g., between 3 and 12 battery cells) connected in series, parallel, or a series-parallel combination in order to produce a battery pack having a desired combination of nominal battery pack voltage and battery capacity.

The battery cells are, for example, cylindrical 18650 battery cells (18 mm diameter and 65 mm length), such as the INR18650-15M lithium-ion rechargeable battery cell manufactured and sold by Samsung SDI Co., Ltd. of South Korea. In other embodiments, the battery cells are, for example, cylindrical 14500 battery cells (14 mm diameter and 50 mm length), 14650 battery cells (14 mm diameter and 65 mm length), 17500 battery cells (17 mm diameter and 50 mm length), 17670 battery cells (17 mm diameter and 67 mm length), 18500 battery cells (18 mm diameter and 50 mm length), 26650 battery cells (26 mm diameter and 65 mm length), 26700 battery cells (26 mm diameter and 70 mm length), etc.

The battery cells are lithium-based battery cells having a chemistry of, for example, lithium-cobalt (“Li—Co”), lithium-manganese (“Li—Mn”), or Li—Mn spinel. In some embodiments, the battery cells have other suitable lithium or lithium-based chemistries, such as a lithium-based chemistry that includes manganese, etc. The battery cells within the battery pack 200 provide operational power (e.g., voltage and current) to the power tools. In one embodiment, each battery cell has a nominal voltage of approximately 3.6V, such that the battery pack has a nominal voltage of approximately 18V. In other embodiments, the battery cells have different nominal voltages, such as, for example, between 3.6V and 4.2V, and the battery pack has a different nominal voltage, such as, for example, 10.8V, 12V, 14.4V, 24V, 28V, 36V, between 10.8V and 36V, etc. The battery cells also have a capacity of, for example, between approximately 1.0 ampere-hours (“Ah”) and 5.0 Ah. In exemplary embodiments, the battery cells have capacities of approximately, 1.5 Ah, 2.4 Ah, 3.0 Ah, 4.0 Ah, between 1.5 Ah and 5.0 Ah, etc.

The present disclosure is discussed with respect to use of a handheld power tool 100, for example, a hammer drill using a removeable battery pack 200. However, as would be appreciated by one skilled in the art, the present disclosure could be implemented using any combination of handheld power tools or other electrically operated devices using any combination of power sources. For example, the present disclosure could be implemented within a corded power tool, a power tool with an integrated battery and/or battery cells, etc., without departing from the scope of the present disclosure.

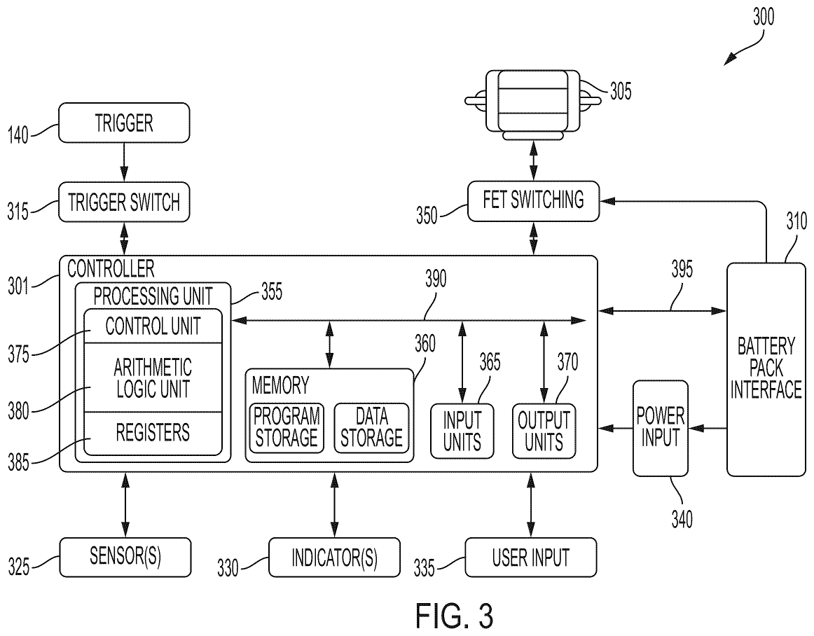

FIG. 3 illustrates a control system 300 for the hand-held power tool 100. The control system can be part of or otherwise connected to a printed circuit board (“PCB”) and can include a controller 301. The controller 301 is electrically and/or communicatively connected to a variety of modules or components of the hand-held power tool 100. For example, the illustrated controller 301 is electrically connected to a motor 305, a battery pack interface 310 (connectable to the battery pack 200 via a battery pack receptacle), a trigger switch 315 (connected to the trigger 140), one or more sensors or sensing circuits 325, one or more indicators 330, a user input module 335, a power input module 340, and a FET switching module 350 (e.g., including a plurality of switching FETs). The controller 301 includes combinations of hardware and software that are operable to, among other things, control the operation of the hand-held power tool 100, monitor the operation of the hand-held power tool 100, activate the one or more indicators 330 (e.g., an LED), etc.

The controller 301 includes a plurality of electrical and electronic components that provide power, operational control, and protection to the components and modules within the controller 301 and/or the hand-held power tool 100. For example, the controller 301 includes, among other things, a processing unit 355 (e.g., a microprocessor, a microcontroller, electronic processor, electronic controller, or another suitable programmable device), a memory 360, input units 365, and output units 370. The processing unit 355 includes, among other things, a control unit 375, an arithmetic logic unit (“ALU”) 380, and a plurality of registers 385 (shown as a group of registers in FIG. 3), and is implemented using a known computer architecture (e.g., a modified Harvard architecture, a von Neumann architecture, etc.). The processing unit 355, the memory 360, the input units 365, and the output units 370, as well as the various modules or circuits connected to the controller 301 are connected by one or more control and/or data buses (e.g., common bus 390). The control and/or data buses are shown generally in FIG. 3 for illustrative purposes. The use of one or more control and/or data buses for the interconnection between and communication among the various modules, circuits, and components would be known to a person skilled in the art in view of the embodiments described herein.

The memory 360 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 355 is connected to the memory 360 and executes software instructions that are capable of being stored in a RAM of the memory 360 (e.g., during execution), a ROM of the memory 360 (e.g., on a generally permanent basis), or another non-transitory computer readable medium such as another memory or a disc. Software included in the implementation of the hand-held power tool 100 can be stored in the memory 360 of the controller 301. The software includes, for example, firmware, one or more applications, program data, filters, rules, one or more program modules, and other executable instructions. The controller 301 is configured to retrieve from the memory 360 and execute, among other things, instructions related to the control processes and methods described herein. In other constructions, the controller 301 includes additional, fewer, or different components.

The battery pack interface 310 includes a combination of mechanical components (e.g., rails, grooves, latches, etc.) and electrical components (e.g., one or more terminals) configured to and operable for interfacing (e.g., mechanically, electrically, and communicatively connecting) the hand-held power tool 100 with a battery pack (e.g., the battery pack 200). For example, power provided by the battery pack 200 to the hand-held power tool 100 is provided through the battery pack interface 310 to the power input module 340. The power input module 340 includes combinations of active and passive components to regulate or control the power received from the battery pack 200 prior to power being provided to the controller 301. The battery pack interface 310 also supplies power to the FET switching module 350 to be switched by the switching FETs to selectively provide power to the motor 305. The battery pack interface 310 also includes, for example, a communication line 395 for provided a communication line or link between the controller 301 and the battery pack 200.

The indicators 330 include, for example, one or more light-emitting diodes (“LEDs”). The indicators 330 can be configured to display conditions of, or information associated with, the hand-held power tool 100. For example, the indicators 330 are configured to indicate measured electrical characteristics of the hand-held power tool 100, the status of the battery pack 200, etc. The user input module 335 is operably coupled to the controller 301 to, for example, select a forward mode of operation or a reverse mode of operation, a torque and/or speed setting for the hand-held power tool 100 (e.g., using torque and/or speed switches), etc. In some embodiments, the user input module 335 includes a combination of digital and analog input or output devices required to achieve a desired level of operation for the hand-held power tool 100, such as one or more knobs, one or more dials, one or more switches, one or more buttons, etc.

The controller 301 is configured to determine whether a fault condition of the hand-held power tool 100 is present and generate one or more control signals related to the fault condition. For example, the sensors 325 include one or more current sensors, one or more speed sensors, one or more Hall Effect sensors, one or more temperature sensors, etc. For example, the speed of the motor 305 can be determined or calculated using a plurality of Hall Effect sensors which sense the rotational position of a rotor. The controller 301 calculates or includes, within memory 360, predetermined operational threshold values and limits for operation of the hand-held power tool 100. For example, when a potential thermal failure (e.g., of a FET, the motor 305, etc.) is detected or predicted by the controller 301, power to the motor 305 can be limited or interrupted until the potential for thermal failure is reduced. If the controller 301 detects one or more such fault conditions of the hand-held power tool 100 or determines that a fault condition of the hand-held power tool 100 no longer exists, the controller 301 is configured to provide information and/or control signals to another component of the battery pack 200 (e.g., the battery pack interface 310, the indicators 330, etc.).

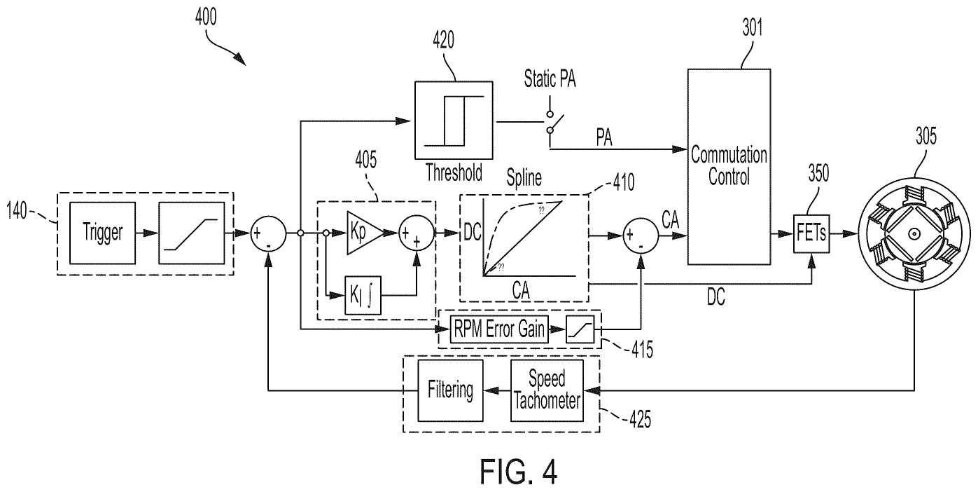

FIG. 4 depicts an example embodiment of a control block diagram 400 for implementing steps of the present disclosure. The control block diagram 400 depicts a BLDC commutation algorithm allowing customizable operation of a particular tool to provide desirable operating characteristics. For example, the BLDC control algorithm can be implemented on the hand-held power tool 100 to enable the motor 305 to operate at a higher speed at low torque conditions. Initially, a speed reference is generated by the trigger 140 (and saturation) signal. In some embodiments, the actual motor speed of the motor 305 is computed by the controller 301 using a frequency of Hall effect sensor transitions. The calculated actual motor speed is then subtracted off from the speed reference value to generate a speed error. This speed error branches off in three separate paths.

In some embodiments, the first path (center path in FIG. 4) feeds the speed error into a Proportional-Integral (PI) regulator (or controller) 405. The output of the PI regulator 405 is fed to a spline function block 410. For example, the output of the PI regulator 405 can be fed into a spline function block 410 that has been modeled as a linear spline for providing operation at the maximum output. Other functions could be utilized for providing different operating conditions, modes, etc., of the power tool 100. The spline function block 410, as depicted in FIG. 4, has two outputs: a Conduction Angle (CA) (or Commutation Angle) and the duty cycle (DC). The CA output is provided to the controller 301 (or a separate commutation control) and the DC output is provided to the FETs 350. By the nature of the PI regulator 405, the higher the speed error, the higher will be the CA value out of the spline function block 410 (based on hardware capability, it saturates to an upper limit set in the code, as discussed in greater detail herein.

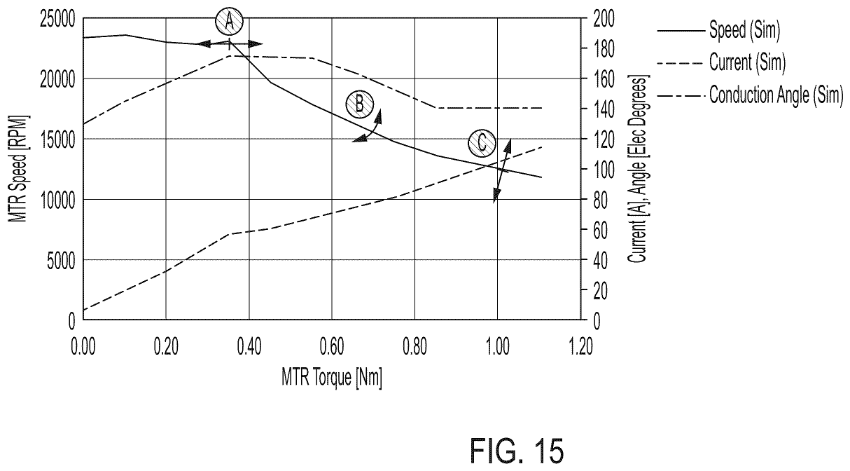

In operation, as the hand-held power tool 100 is loaded down, and the motor 305 starts to slow down, the speed error builds up and the spline function block 410 starts bumping up the CA to bring the speed back to the reference value. However, when the spline function block 410 reaches the max CA limit, the CA output value saturates and the speed starts to dip (assuming the DC value is saturated at 100% as well) thereby increasing the speed error as seen at the knee of the curve in FIG. 15. Beyond the knee in the curve, the control block diagram 400 can be configured to start easing up on the value of CA to decrease the current drawn (e.g., to stay within the thermal limits of the hand-held power tool 100).

In some embodiments, CA “roll-off” is controlled by the second branch (lower branch in FIG. 4) which includes a rotations per minute (RPM) error calculation block 415. The motor RPM error calculation block 415 provides logic for calculating thresholds for switching on or off the phase angle at a particular speed. If the speed error is non-zero, the output of RPM Error calculation block 415, speed_error*RPM_error_gain, is subtracted off from the CA output from the spline function block 410 and sent to the controller 301 of the hand-held power tool 100. The final CA being sent to the controller 301 (commutation controller) has a lower saturation limit of 120 degrees (i.e., traditional block commutation). Other limits higher than 120 can also be set in the firmware to prevent excessive speed roll-off.

The third path (upper path in FIG. 4) includes logic for error monitoring 420. In some embodiments, the speed error is monitored, and a hysteresis threshold limiter sends a static phase advance angle to the controller 301 (or commutation controller). By default, the threshold limits are set such that the static Phase Angle (PA) (or phase advance) is always on and does not depend on the speed error value. This may be implemented to eliminate generating PA switch-on transients.

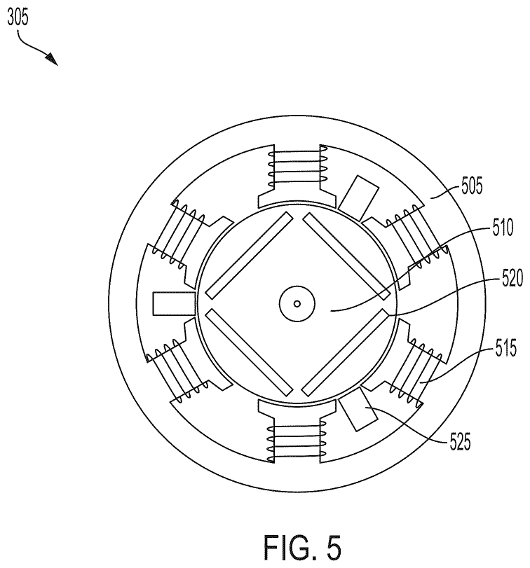

Referring to FIG. 5, in some embodiments, the control block diagram 400 can be implemented using a three-phase BLDC motor, for example, motor 305. The motor 305 includes a stator 505 and a rotor 510. The stator 505 includes a plurality of stator windings 515 and the rotor 510 includes a plurality of fixed magnets 520. The controller 301 can be configured to control the stator 505 current in such a way that maximum torque is obtained at a given speed. In the example motor 305 provided in FIG. 5, the stator 505 has three-phase winding including three stator winding pairs 515, while the rotor is in the form of a permanent magnet(s) rotor 510. The stator 505 will remain stationary while the rotor 510 rotates based on the current being applied to the stator windings 515. The speed of the rotation can be controlled by controlling the stator 505 of the motor 305, for example, by controlling the DC input voltage of a three-phase inverter (or FET switching 350).

In some embodiments, the motor 305 includes a plurality of rotor position sensors 525 that produce electrical signals that indicate the current position of the rotor 510. The rotor position sensors 525 can include any combination of sensors, such as Hall effect sensors. A Hall effect sensor varies its output voltage based on the strength of the applied magnetic field. The output from the Hall sensor can be provided as feedback to the controller 301 which can use the information to modify operation of the motor 305. The feedback provided by the rotor position sensors 525 to the controller 301 will be useful in optimizing the desired operation of the motor 305, as discussed in greater detail herein. For example, the rotor position sensors 525 can provide a logic 1 when exposed to the N-type pole of the rotor and logic 0 otherwise.

The Hall sensors can be implemented with 120 degrees apart from one another or with 60 degrees of spacing. A motor with three Hall sensors spaced 120 degrees apart can provide six valid combinations of binary states: 001, 010, 011, 100, 101, and 110. This combination of commutation steps is commonly referred to as a six-step commutation. The sensors provide the angular position of the rotor in degrees in the multiples of 60, which the controller uses to determine the 60-degree sector where the rotor is present. When the rotor 510 reaches the open-loop position zero, it aligns with a first phase axis (e.g., phase A) of the stator 505. At this position, corresponding to a Hall state, the six-step commutation algorithm energizes the next two phases of the stator winding, so that the rotor always maintains a torque angle (angle between rotor d-axis and stator magnetic field) of 90 degrees with a deviation of 30 degrees. In a six-step commutation Hall sequence calibration, the algorithm can drive the motor 305 over a full mechanical revolution and compute the Hall sensor sequence with respect to position zero of the rotor in open-loop control.

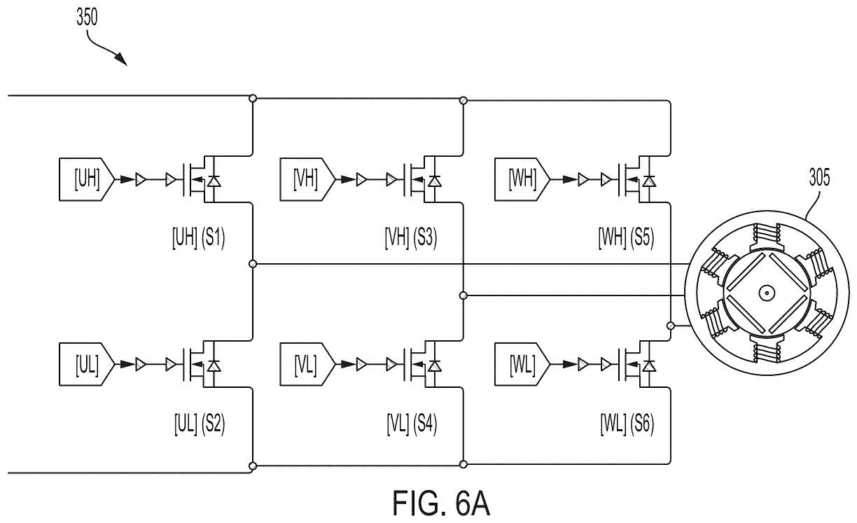

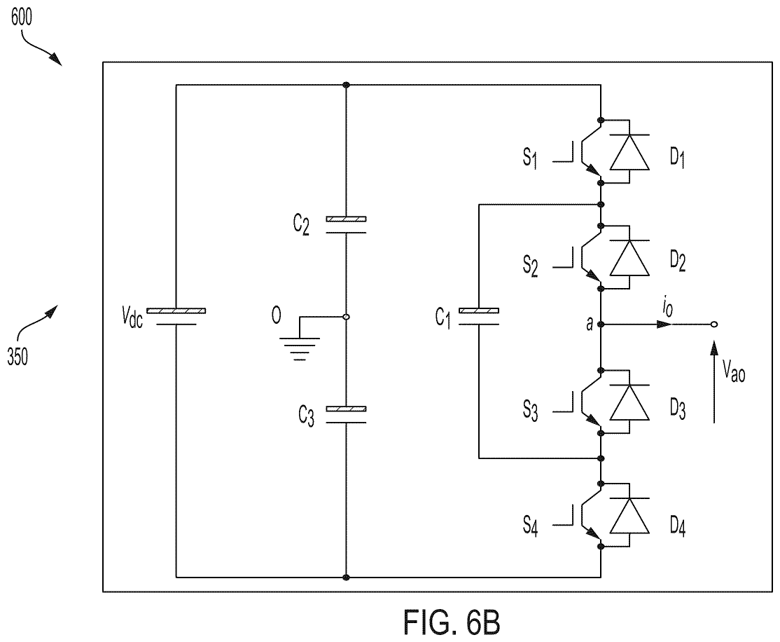

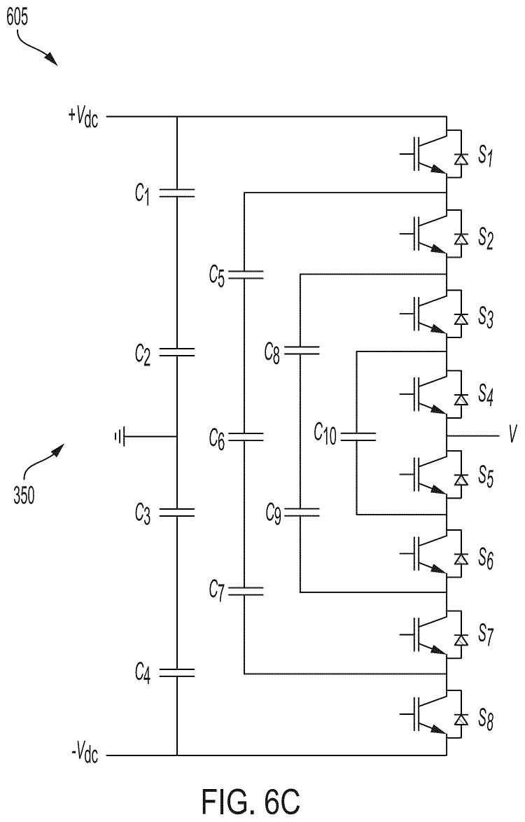

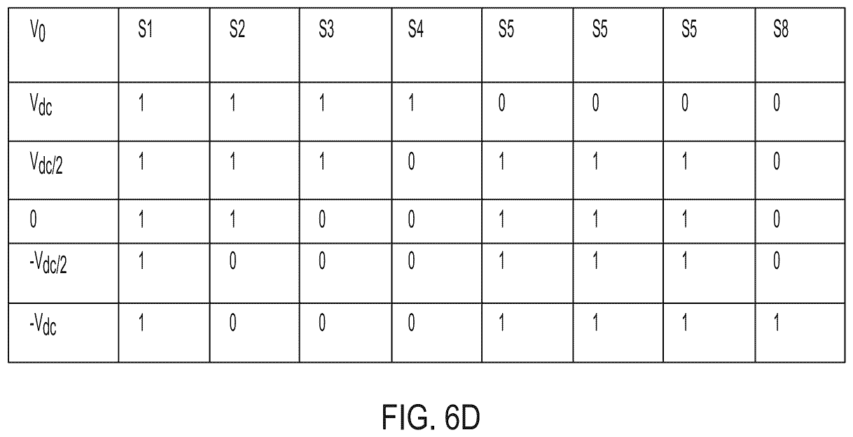

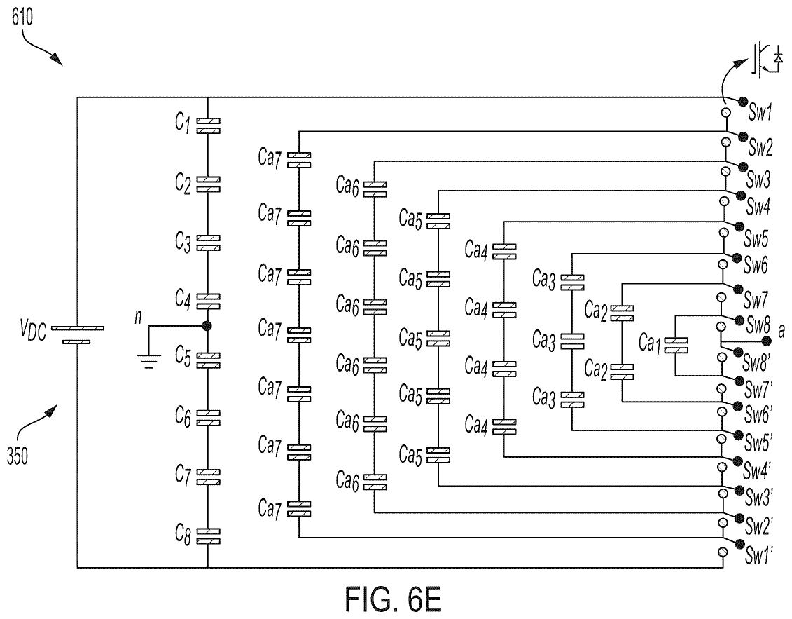

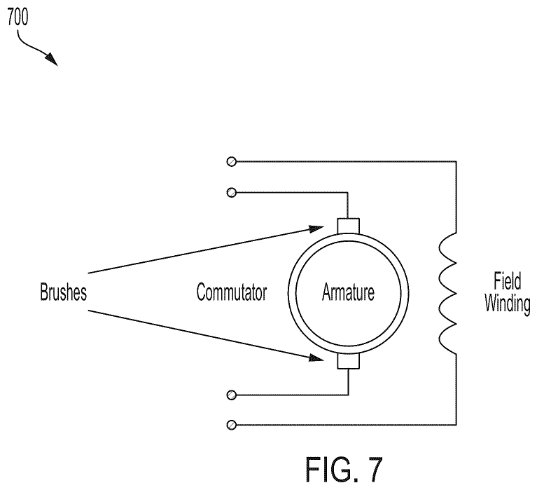

Referring to FIG. 6A, in some embodiments, a switching array (e.g., a transistor or FET switching array) 350 for the power tool 100 including a BLDC motor 305 is provided. The switching array 350 includes three high-side FETs, UH (S1), VH (S3), and WH (S5), and three low-side FETs, UL (S2), VL (S4), and WL (S6), each having a first state (or conducting state) and a second state (or non-conducting state). In some embodiments, the switching array 350 is used to selectively apply power from the power source (e.g., battery pack 200) to the motor 305, for example, as discussed with respect to FIG. 5. In some embodiments, a twelve-step dynamic commutation is created by inserting odd gate driving cases in between the classical six-step block commutation by performing control logic based on Hall effect edge transitions. The odd gate driving cases are used to shape the electromagnetics between the rotor field and stator field of the BLDC motor 305 by switching logic which shifts in time with respect to position and Hall effect sensor transitions.

For example, the FET switching array 350 can be configured such that every even state is normal six-step commutation turning on the appropriate phase gate logic while every odd state is an extra or intermediate condition where three FETs are driven “ON” with gate control logic. In this case partial enabling of the odd steps can be achieved by only turning on the number of desired FETs. For example, turning on multiple high-side FETs or low-side FETs enables the ability to excite multiple gates instead of a single gate for each commutation step, allowing for partial current and programmability of the motor 305 behavior. The specific manner in which the high-side switches and the low-side switches are controlled is described in greater detail herein. The FET switching array 350 can be implemented for controlling the three phases of the stator windings, based on feedback from the rotor position sensors 525 (e.g., Hall effect sensors). For example, the MCU can be programmed to appropriately switch the FETs based on the data from the rotor position sensors 525. The fields produced by the stator and rotor remain stationary with respect to each other. In some embodiments, a multi-level inverter (e.g., a five-level, a nine-level inverter, etc.) is implemented in the power tool 100.

In some embodiments, the twelve-step commutation setup for the FET switching array 350 includes several FETs representing a single lower or upper FET (e.g., a multi-level inverter). The multiple high transistor (or switches) and/or multiple low transistor configuration allow the controller 301 to discretely turn on any number of high or low transistors based on desired performance (e.g., torque, speed, power consumption, etc.). For example, FIGS. 6B, 6C, and 6E each illustrate multi-level inverters for use in the power tool 100. FIG. 6B illustrates a three-level flying capacitor multi-level (“FCML”) inverter 600. FIG. 6C illustrates a five-level FCML inverter 605. FIG. 6E illustrates a nine-level FCML inverter 610. Although, multi-level FCML inverters are illustrated, another type of multi-level inverter can also be used in the power tool 100. FIG. 6D illustrates a table that includes switching states of the five-level FCML inverter 605 for driving the motor 305. Similar tables are used for driving the motor 305 with a three-level inverter, a nine-level inverter, an eleven-level inverter, etc., adjusted for the required number of switches. Each switch in the inverter 350 includes its own gate driver for driving the switch to the appropriate conduction state (i.e., ON or OFF). For example, the inverters 600, 605, and 610 each represent one phase of the three phases that would be used to drive the motor 305. As a result, for the high-side and low-side of each phase of the inverter 350, a plurality of high-side switches and/or a plurality of low-side switches can be controlled ON (i.e., to conduct), which allows for more precise control of the voltage that is supplied to the motor 305.

In some embodiments, the control block diagram 400 can be used to implement a field-weakening control loop. The term field-weakening stems from the technique used to speed up brushed DC motors beyond what simple armature-voltage control would allow for. This technique involves weakening the voltage of the field coil, as shown in Error! Reference source not found. 7, through shaping the electromagnetics between the rotor field and stator field by switching logic which shifts in time with respect to position and transitions between the rotor position sensors 525 (e.g., Hall transitions). In some embodiments, one or more control algorithms or processes can be implemented to specify commutation and/or phase angles to control a level of weakening. The decreased field voltage decreases the magnetic field of the rotor 510 causing it to speed up. By weakening or strengthening the field relative to position, different speed and torque characteristics are realized.

In more complex machines like synchronous permanent-magnet (SPM) machines, the absence of any field windings is countered by careful control of the excitation voltage of the stator coils to achieve this same effect. To field-weaken (or flux-weaken) such machines, the excitation signals are controlled such that there exists a component of current (−Id) which rotates synchronously and is oriented such that it creates a magnetic field exactly opposite to that created by the permanent magnets embedded in the rotor. This “inverted virtual magnet” created by this current component reduces the net magnetic field strength of the machine, thus speeding it up. Id produces no torque. Instead, its orthogonal component, Iq, is the solely responsible torque-producing current component. i_{source}=\sqrt{(i_{d}²+i_{q}²)}.

Embodiments described herein focus on using a modified variant of the traditional block commutation conduction angle control. The variant on traditional black commutation implements dynamic field weakening based on a twelve-step commutation sequence which effectively increases a conduction angle ON time for driving switch. Increasing the conduction angles in the block commutation control scheme effectively increases both the speed as well as the torque capability of the motor. Thus, this “extra” conduction angle functions to inject both Iq and −Id into the motor.

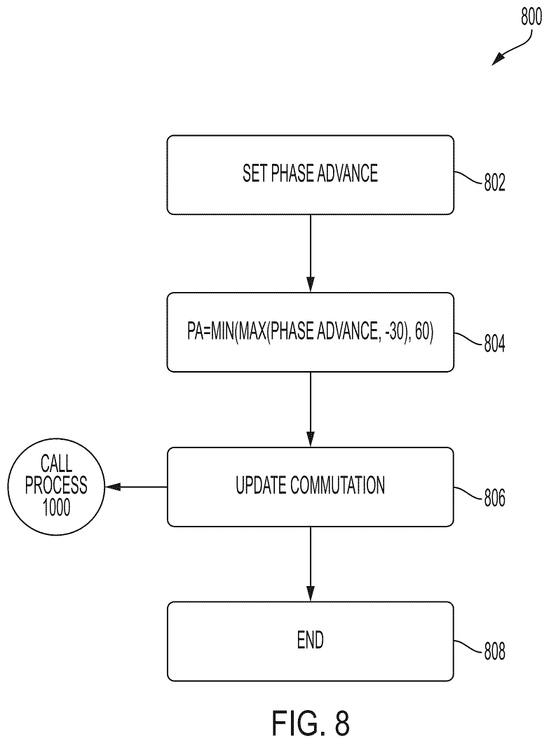

Referring to FIGS. 8, 9, and 10, in some embodiments, the controller 301 can execute set phase angle process 800 and set commutation angle process 900 to change the field weakening characteristics of the motor 305 as part of a field weakening control code.

FIG. 8 depicts a process 800 for setting a phase angle for the motor commutation. At STEP 802, a call to set the phase angle is called (e.g., following activation of the trigger 140). At STEP 804, the phase angle is set by executing the function of min(max(PHASE_ANGLE, −30), 60) to determine the minimum and maximum values for the phase angle. At STEP 806, the process 800 calls process 1000 to update the phase angle of the motor commutation using the set phase angle value from STEP 804. At STEP 808, after calling the process 1000 to update the phase angle of the commutation, the process 800 ends.

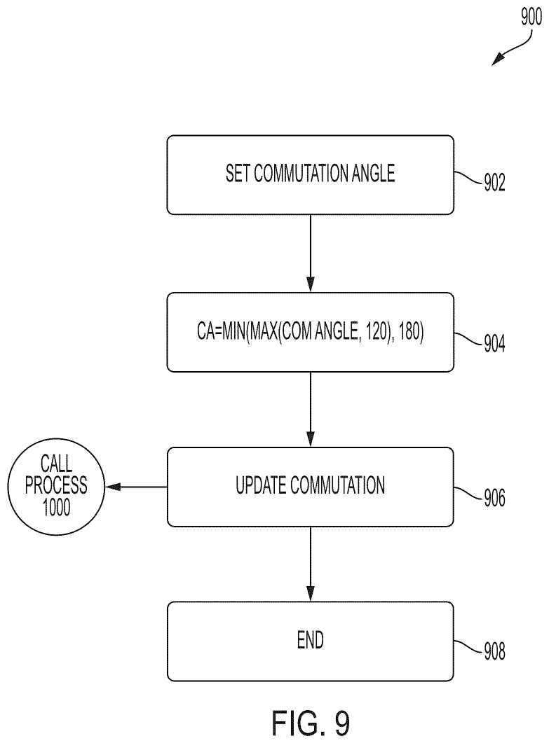

FIG. 9 depicts a process 900 for setting a commutation angle for the motor commutation. At STEP 902, a call to set the phase angle is called (e.g., following activation of the trigger 140). At STEP 904, the commutation angle is set by executing the function of min(max(COM_ANGLE, 120), 180) to determine the minimum and maximum values for the commutation angle. At STEP 906, the process 900 calls process 1000 to update the phase angle of the commutation using the set commutation angle value from STEP 904. At STEP 908, after calling the process 1000 to update the commutation angle of the motor commutation, the process 900 ends.

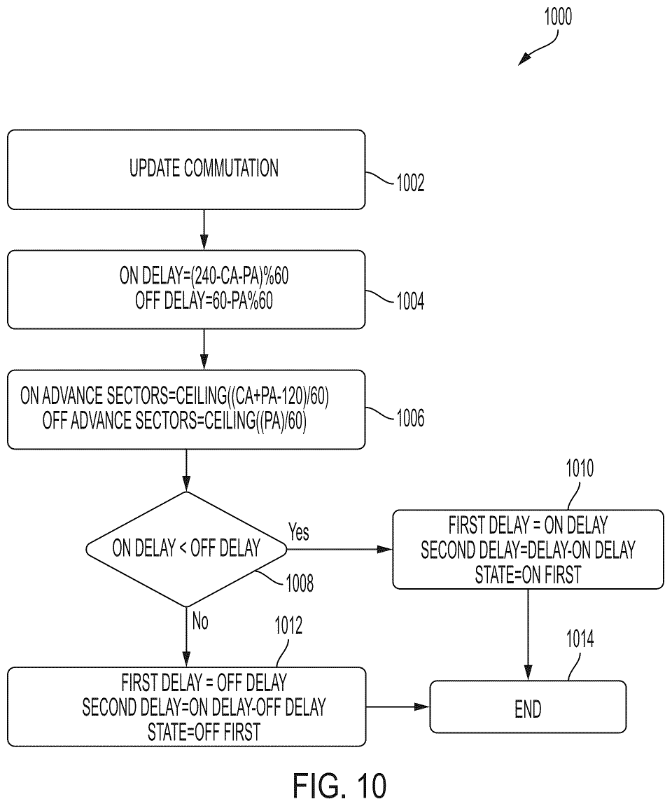

FIG. 10 depicts a process 1000 for updating the motor commutation of the motor 305. The process 1000 is an internal function that each of process 800 and 900 call to set up new data for the next Hall transition. Once the process 1000 is complete, the resulting data is transferred to be active once that transition occurs. At STEP 1002, the process 1000 receives a command (or call) to update the motor commutation from one of the other processes 800 or 900. The command can be at least one of a conduction angle (“CA”) command and a phase advance (“PA”) command to compute at least one of the ON delay, OFF delay, advance sectors, and initial state that are needed each time the commands change. At STEP 1004, the process 1000 sets the ON delay and the OFF delay values. The ON delay can be set by subtracting conduction angle from 240 and subtracting the phase angle from the conduction angle. The OFF delay can be set by subtracting the phase angle from 60. In STEP 1004, the delay variables contain the angles in degrees from the beginning of a hall transition to the desired commutation action (either ON or OFF). The ratio R=delay/60 is the fraction of period between halls to set the phase angle interrupt to trigger.

At STEP 1006, the process 1000 sets the ON_ADVANCE_SECTORSs based on the function of ceiling((ca+pa-120)/60) and OFF_ADVANCE_SECTORS based on the function of ceiling((pa)/60). The on and off advance sector variables are the number of sectors to advance the commutation. The range of values is [0, 2], i.e., 0, 1, 2, which is used as an offset from the basic trapezoidal commutation traditionally used in 6-step commutation systems.

At STEP 1008, a determination is made whether an ON_DELAY is less than an OFF_DELAY, as calculated from STEP 1004. If the ON_DELAY is less than the OFF_DELAY, the process 1000 advances to STEP 1010, if not, then the process 1000 advances to STEP 1012. At STEP 1010, the first delay is set to the ON_DELAY value from STEP 1004, the second delay is set to the total delay minus the ON_DELAY value from STEP 1004, and the state is set to ON_FIRST. At STEP 1014 the process 1000 ends. At STEP 1012, the first delay is set to the OFF_DELAY value from STEP 1004, the second delay is set to the ON_DELAY minus the OFF_DELAY value from STEP 1004, and the state is set to OFF_FIRST. At STEP 1014 the process 1000 ends. The process 1000 can be repeated by the controller 301 for each commutation step of the motor 305. The variables produced during process 1000 should be dispatched to the interrupt handler(s) such that the instructions including these variables are fully executed without interruption.

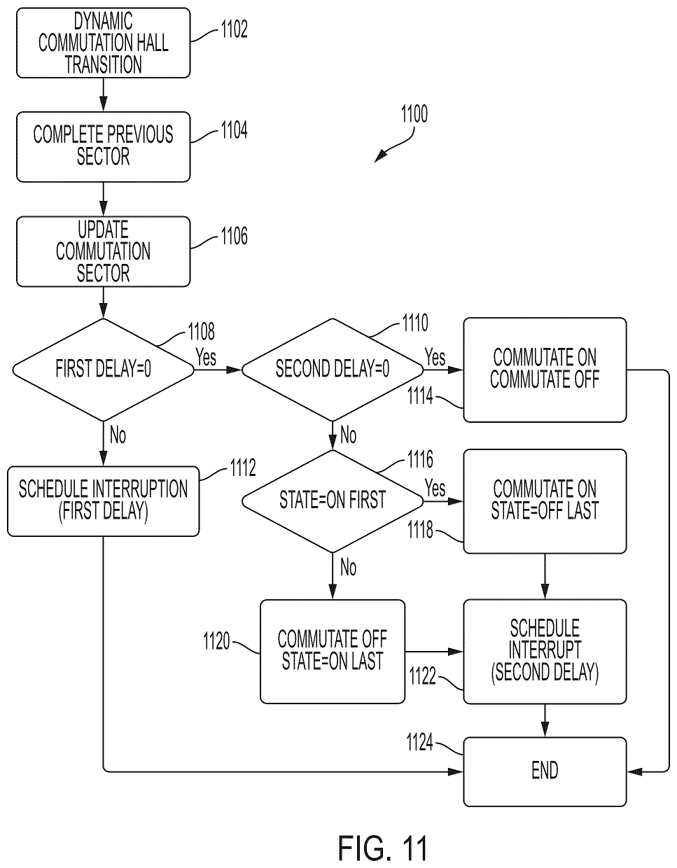

Referring to FIG. 11, in some embodiments, the controller 301 can call a hall transition interrupt process 1100 for implementing a dynamic commutation hall transition. In one example, the hall transition interrupt process 1100 handles the hall transition interrupt for the motor 305. In some embodiments, when the motor 305 is below a threshold speed, the motor commutation will operate the same as a static phase angle and correspond to a standard trapezoidal commutation when CA=120 and PA=0. At STEP 1102, the dynamic commutation hall transition is initiated. This process can be initiated based on any combination of factors, for example, activation of the power tool 100 (e.g., via trigger 140) or by selection of a particular operational mode of the power tool 100. During acceleration, motor timing gets compressed, so it is possible that the previous commutation cycle may not have been fully completed.

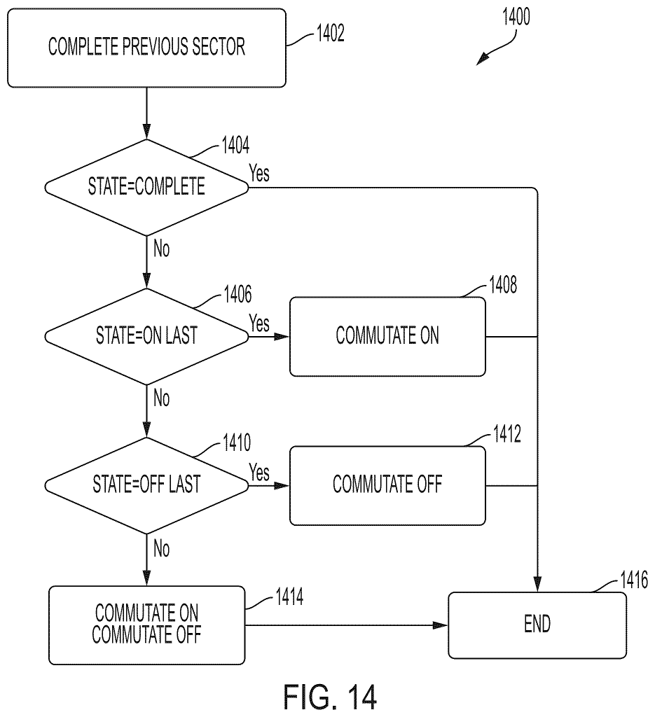

At STEP 1104, the process 1100 includes first checking if the previous commutation cycle completed, if not, the process 1100 completes or waits for the previous commutation cycle to be completed. For example, the process 1100 can trigger a process 1400 (see FIG. 14) for completing the previous commutation cycle. Once completed, the process 1100 advances to STEP 1106. At STEP 1106, the process 1100 updates the data from the commutation interface, including the initial value of the state variable, for example, from process 1000. At STEP 1106, the process 1100 also updates the CURRENT_SECTOR of motor rotation.

At STEP 1108 a determination is made whether the FIRST_DELAY is equal to zero, if yes the process 1100 advances to STEP 1110, and if not. the process 1100 advances to STEP 1112. At STEP 1112 an interruption is scheduled for the first delay and the process 1100 ends at STEP 1124. Returning to STEP 1110, a determination is made whether the SECOND_DELAY is equal to zero. If yes, the process 1100 advances to STEP 1114, and if not, the process 1100 advances to STEP 1116. At STEP 1114, the process 1100 turns the commutation phases ON or OFF. The phase being turned ON or OFF is based on the CURRENT_SECTOR+the ON or OFF ADVANCE_SECTORS (e.g., from process 1000). After STEP 1114, the process 1100 ends at STEP 1124.

Returning to STEP 1116, the process 1100 determines if the state is set to ON_FIRST. If yes, the process 1100 advances to STEP 1118, and if not, the process 1100 advances to STEP 1120. At STEP 1118 the COMMUTATION ON STATE is set to OFF_LAST, whereas at STEP 1120 the COMMUTATION_OFF_STATE is set to ON_LAST. After the respective state changes, both STEPs 1118 and 1120 will advance to STEP 1122. At STEP 1122 an interruption is scheduled for the second delay and the process 1100 ends at STEP 1124. The process 1100 can be executed for each transition to a subsequent commutation step.

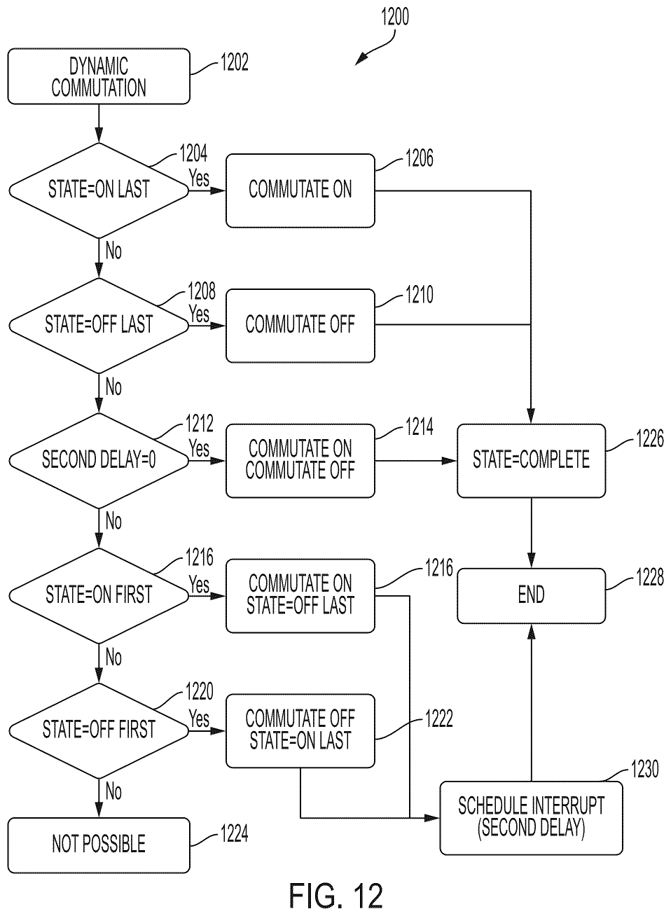

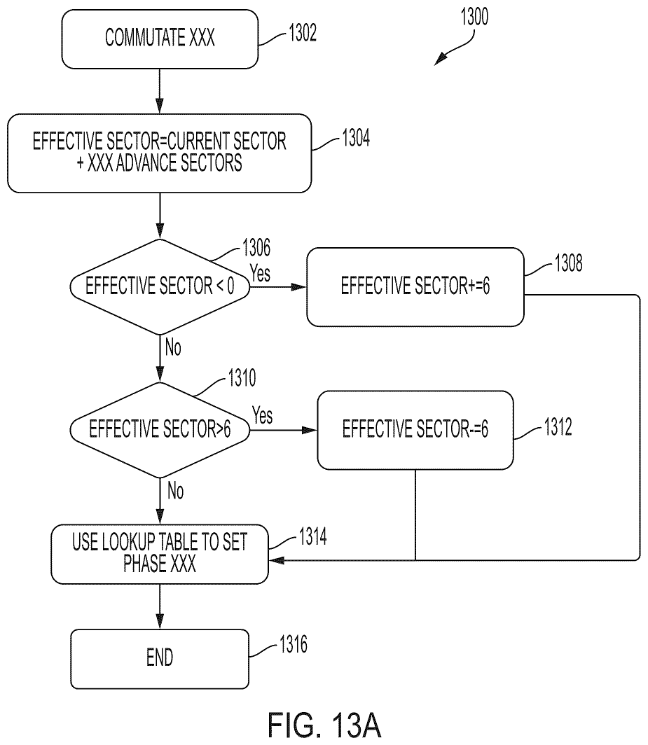

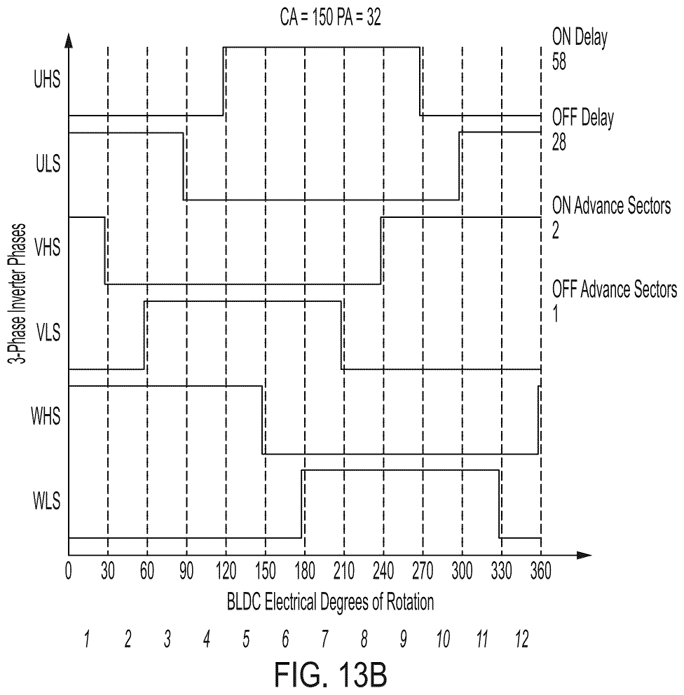

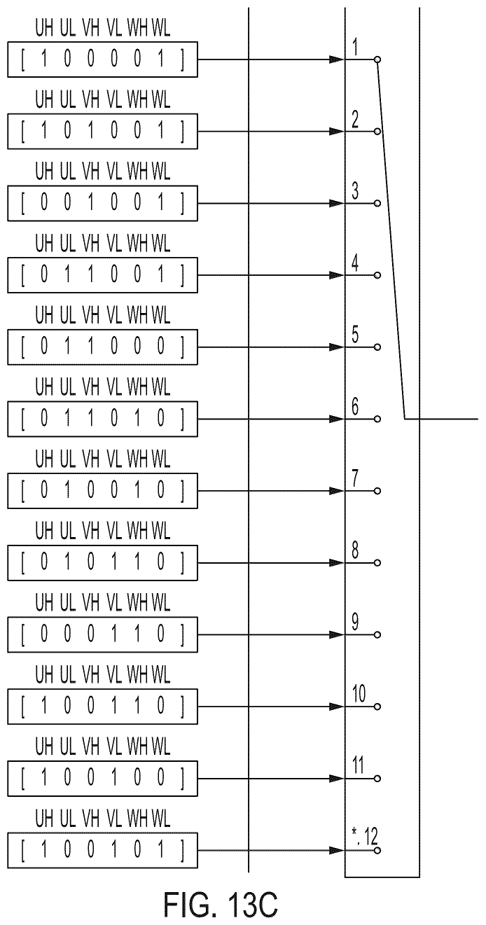

Referring to FIG. 12, in some embodiments, a dynamic commutation interrupt process 1200 can be provided to handle phase interrupts, for example, triggered in process 1100, for switching from one commutation phase to another. Process 1200 executes the commutation logic based upon the state variable and schedules a second phase interrupt, if necessary. At STEP 1202 the dynamic commutation process 1200 is initiated, for example, based on a call from STEP 1112 or 1122 from process 1100. At STEP 1204, the process 1200 checks whether the state of a commutation switch is equal to ON_LAST. If yes, the process 1200 advances to STEP 1206 where COMMUTATE_ON is triggered, (e.g., process 1300 of FIG. 13A) if not, the process 1200 advances to STEP 1208. At STEP 1208 the process 1200 checks whether the state is equal to OFF_LAST. If yes, the process 1200 advances to STEP 1210 where COMMUTATE_OFF is triggered (e.g., process 1300 of FIG. 13A), if not, the process advances to STEP 1212. At STEP 1212, the process 1200 determines whether the SECOND_DELAY is equal to zero. If yes, the process 1200 advances to STEP 1214 where COMMUTATE_ON/COMMUTATE_OFF are triggered, (e.g., process 1300A of FIG. 13). If not, the process 1200 advances to STEP 1216. After each of the commutation functions in STEPs 1206, 1210, 1214, the process 1200 advances to STEP 1226 where the state is designated as complete and advance to the process 1200 end at STEP 1228. The process 1200 can be executed, for example, for each switch in the FET switching module 350 for each commutation step of the motor 305.

Returning to STEP 1216, the process 1200 determines whether the state is equal to ON_FIRST. If yes, the process advances to STEP 1218 where the COMMUTATION_ON is triggered and state is set to OFF_LAST. If no, the process advances to STEP 1220. At STEP 1220, the process 1200 determines whether the state is equal to OFF_FIRST. If yes, the process 1200 advances to STEP 1222 where the COMMUTATION_OFF is triggered and state is set to ON_LAST. If no, the process 1200 advances to STEP 1224. After completing STEP 1222, the process 1200 advances to STEP 1230 where a schedule interrupt with a second delay is triggered. After the interrupt is set at STEP 1230, the process 1200 ends at 1228.

Referring to FIG. 13A, in some embodiments, a commutation function for actually commutating the motor 305 is executed as process 1300. At STEP 1302, COMMUTATE_XXX process is trigged based on at least one call from the COMMUTATE_ON and COMMUTATE_OFF triggers, for example, from processes 1100 (the hall interrupt handler) and 1200 (the phase interrupt). The COMMUTATE_ON and COMMUTATE_OFF triggers both trigger COMMUTATE_XXX. At STEP 1304 the EFFECTIVE_SECTOR value is set. For a counterclockwise direction of the motor 305, the EFFECTIVE_SECTOR value is set using the CURRENT_SECTOR value added to the XXX_ADVANCE_SECTORS from process 1100. For a clockwise direction of the motor 305 the EFFECTIVE_SECTOR value is set using the CURRENT_SECTOR value subtracted from the XXX_ADVANCE_SECTORS from process 1100.

At STEP 1306 the process 1300 determines whether the EFFECTIVE_SECTOR is less than zero. If yes, the process 1300 advances to STEP 1308 where the EFFECTIVE_SECTOR is set to sector six. If no, the process 1300 advances to STEP 1310. At STEP 1310, the process 1300 determines whether the EFFECTIVE_SECTOR is greater than six. If yes, the process 1300 advances to STEP 1312 where the EFFECTIVE_SECTOR is set to sector 6. If no, the process 1300 advances to STEP 1314. Once each of the STEPs 1308, 1310, or 1312 are completed, they advance to STEP 1314. At STEP 1314 a lookup table is used to set the phase XXX value, sets the value to ON or OFF, and ends at STEP 1316. For example, STEP 1314 can use a lookup table such as TABLE 1 provided below to determine which sector of rotation corresponds to which phases being ON or OFF.

TABLE 1

| Effective | Counterclockwise | CCW OFF | Clockwise (CW) | CW OFF |
|---|---|---|---|---|
| Sector | (CCW) ON Phase | Phase | ON Phase | Phase |
| 1 | WL | V | UH | V |
| 2 | VH | U | WL | U |
| 3 | UL | W | VH | W |
| 4 | WH | V | UL | V |
| 5 | VL | U | WH | U |
| 6 | UH | W | VL | W |

Referring to FIG. 13B, a timing diagram for a twelve-step dynamic commutation of the motor 305 implemented with the processes 800-1300 is illustrated. In the illustrated commutation cycle for the motor 305, the CA is set to 150 degrees and PA is set to 32 degrees. FIG. 13C illustrates the binary (ON or OFF) conditions for each switch of the FET switching module 350. As shown in FIG. 13C, the ODD numbered commutation steps correspond to the conventional six-step commutation, while the EVEN numbered commutation steps correspond to additional or intermediate steps where an additional high or low side FET is ON (i.e., either two high-side switches are ON or two low-side switches are ON. Although FIGS. 13B and 13C illustrate the commutation steps in a seemingly fixed or static manner, the timing used to implement the twelve-step commutation is dynamically determined as set forth above in the processes 800-1300. In some embodiments, the dynamic twelve-step commutation is implemented, for example, for speeds above a threshold speed value, for speeds below a threshold speed value, for torques above a threshold torque value, for torques below a threshold torque value, or for any speed and any torque output of the power tool 100. The phase transitions illustrated in FIG. 13B with respect to a single commutation cycle are not fixed, and are instead dynamically calculated as set forth above. As such, each step of the twelve-step commutation sequence is dynamically controlled based on the above-calculated ON and OFF delays, conduction angle, phase advance, etc.

Referring to FIG. 14, in some embodiments, an over-run handling process 1400 can be run as part of a triggered interrupt. For example, the process 1400 can be run as part of process 1100 (the hall interrupt) when the previous commutation cycle has not completed (e.g., see STEP 1104). If the previous commutation cycle did not complete, the process 1400 is triggered. The process 1400 can be executed before updating the CURRENT_SECTOR and the XXX_ADVANCE_SECTOR variables.

At STEP 1402, the complete process sector is initiated. At STEP 1404, the state is checked to determine whether the commutation cycle has completed. If yes, the process 1400 advances to STEP 1416 to end and return to the interrupting process (e.g., process 1100). If no, the process 1400 advances to STEP 1406. At STEP 1406, the state is checked to determine whether the state is set to ON_LAST. If yes, the process 1400 advances to STEP 1408, where COMMUTATE_ON is run. If no, the process 1400 advances to STEP 1410. At STEP 1410, the state is checked to determine whether the state is set to ON_LAST. If yes, the process 1400 advances to STEP 1412, where COMMUTATE_OFF is run. If no, the process 1400 advances to STEP 1414 where the where COMMUTATE_ON/COMMUTATE_OFF is run. After STEPs 1408, 1412, or 1414 are complete, the process 1400 advances to STEP 1416 where the process 1400 ends such that cycle completes and the next cycle is ready to run.

In operation, embodiments of this disclosure can be used to run the motor 305 at a higher speed at low torque conditions. In some embodiments, this is accomplished through shaping the electromagnetics between the rotor field and stator field by switching logic which shifts in time with respect to position and Hall transitions. By weakening or strengthening the field relative to position, different speed and torque conditions are realized. The electromagnetic shaping and switching can be implemented to implement Hall edge transitions along with user programmable delays to achieve the desired motor operation.

Embodiments of this disclosure implement a twelve-step dynamic commutation. In some embodiments, the combination of the control block diagram 400 and the processes discussed in FIGS. 8-14. The twelve-step commutation is created by inserting odd gate driving cases in between the classical six step block commutation, and performing control logic based on Hall edge transitions. In this configuration, every even state is a normal six step commutation turning on the appropriate phase gate logic and every odd state is an extra condition where three FETs are driven ON with gate control logic, for example, as shown in FIGS. 6, 13B, and 13C. By exciting multiple gates instead of a single gate for odd commutation steps, partial current and programmability of the motor 305 behavior is enabled. Partially enabling the odd steps can be achieved by only turning on the number of desired FETs. In this case the resultant field is only partially altered and partial adjustments along the speed/torque curve are realized. This allows for different tools to adopt different regions of the speed/torque curve based on the needs of the application.

Shaping the speed-torque curve of a censored field-weakened tool can be implemented by tuning certain parameters of the control loop governing the speed-torque characteristics of a handheld power tool 100 running the field-weakening code. FIG. 15 depicts an example tuning parameters chart. The following steps aim to provide guidance for shaping/tuning the speed-torque curve of a tool using this feature. Initially, the dynamic commutation functions (or processes) are enabled in the controller 301 of the tool 100. The controller 301 will start with a default fixed phase angle value in the motor control configuration (e.g., in memory 360), for example, 20 degrees. The fixed value of phase advance angle are provided in degrees, which override the static phase advance parameter value whenever field-weakening/dynamic-commutation is active.

Thereafter, a maximum commutation angle is provided in the motor control configuration of the tool to determine the absolute maximum as to how far the knee of the speed-clipped region can be pushed out to the right (point A in FIG. 15). The maximum commutation angle will be a limiting factor for the max torque at the knee of the curve. The maximum commutation angle can be limited based on performance of a processor for the tool, for example, the firmware algorithm can support a maximum of 175 degrees while a processor will be limited to a maximum commutation angle lower than 175 degrees, which will limit the knee of the curve as well. For the handheld power tool 100, for example, the maximum commutation angle can be 160.40 and can vary depending on the type and/or configuration of the power tool. The maximum commutation angle can be calculated using any combination of methods. For example, the maximum commutation angle can be calculated by 120U+60*(1 −MCTRL_HALL_TRANS_MAX_TIME *MOTOR_MAXIMUM_RPM/5000000.

The maximum commutation angle value can be tuned to adjust the knee of the speed-clipped region. For example, increasing the maximum commutation angle will push out the knee of the curve to the right. In some instances, the maximum commutation angle for the desired knee of the curve may be selected as a value less than the actual maximum commutation angle of the tool (e.g., based on the processor). For example, the power tool can have a maximum commutation angle of 146.

In some embodiments, the slope of the speed-torque curve beyond the knee can be adjusted using the control commutation angle slope parameter in the hardware configuration. The commutation angle slope determines how fast the commutation angle is dropped off after the knee of the curve. Higher values for the commutation angle slope will force the angle to drop off quicker as torque is increased. This parameter is adjusted to tune for the desired speed and current response between the knee and maximum torque points (represented at point B in FIG. 15). The commutation angle slope will start at a default value in the motor control configuration, for example, 3.91. The commutation angle slope can be calculated using any combination of methods. For example, the commutation angle slope can be calculated by calculating the slope (gain) of the drop-off of the conduction angle (degrees/kRPM). A default value can be set to 16 degrees/kRPM

$$( Calc : \frac{16}{{2}^{12}} = 3.91 ; 1 {6}^{*} error >> 12 ) .$$

This value can be tuned depending on the tool and desired performance. For example, the commutation angle slope can be set at 1.46625 for the handheld power tool 100 to achieve the desired performance.

In some embodiments, adjusting the minimum commutation torque to the maximum torque value can limit the current and stop excessive speed roll-off at maximum torque. For example, setting the minimum commutation torque to the maximum torque value at values higher than 120 will result in faster motor speeds at the cost of higher currents (represented at point C in FIG. 15Error! Reference source not found.). The lowest limit this parameter can be set to is 120 (i.e., for traditional block commutation). In some embodiments, the above tuning can be repeated by adjusting the fixed phase angle value to shift the curve by injecting an appropriate phase angle to maintain acceptable currents and motor efficiencies. After changing the maximum phase angle, then the other tuning steps can be repeated for desired results.

In some embodiments, additional tuning parameters, which should not typically need to be changed from their default values, for tuning the torque-speed curves can be provided. These parameters can include but are not limited to minimum speed in rpm, hall transmission max time, motor RPM error commutation angle limit, motor RPM error upper phase angle limit, motor RPM error lower phase angle threshold, field angle slew rate, and motor field angle slew rate. The minimum speed in rpm is required for dynamic commutation to be activated. Setting this to too low of a value can potentially destabilize the startup routine due to fast-changing hall interrupt timings which are used by the dynamic commutation scheme described above to calculate CA values. The hall transmission max time is the maximum time (+1) in microseconds that the hall interrupt requires. This value was found experimentally by monitoring the signal and checking for the worst possible (highest) observed value.

The motor RPM error commutation angle limit is the maximum angle reduction in degrees that the RPM error can generate, which is subtracted off from the CA output of the spline (e.g., MAX_CA−MCTRL_MIN_CA_AT_MAX_TORQUE). The motor RPM error upper phase angle limit is the upper speed threshold for the hysteresis band controller for switching on the fixed PA angle at a particular speed. The motor RPM error upper phase angle limit can be set to a large negative value to effectively always have the PA enabled by default. The motor RPM error lower phase angle threshold is the lower speed threshold for the hysteresis band controller for switching off the fixed PA angle at a particular speed. The motor RPM error lower phase angle can be set to a large negative value to effectively always have the PA enabled by default. It is noted that the different parameter values can be stored in memory 360, for example, defined in the motor control configuration file.

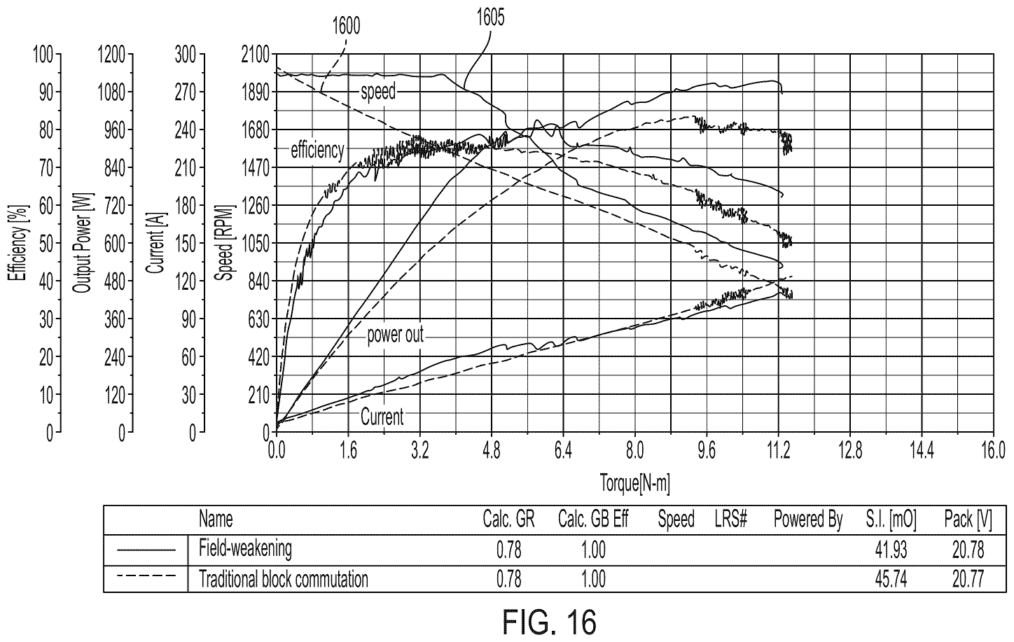

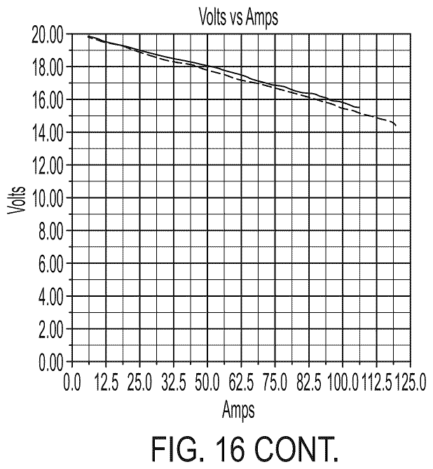

FIG. 16 depicts a plot comparing the performance of a tool running the 12-step commutation algorithm versus running a traditional six-step block commutation algorithm. For example, a speed curve 1600 is illustrated to be considerably lower than a speed curve 1605 for the 12-step commutation algorithm. Therefore, the 12-step commutation scheme described herein allows the power tool 100 to achieve higher speeds that traditional six-step block commutation at the expense of, for example, greater current draw.

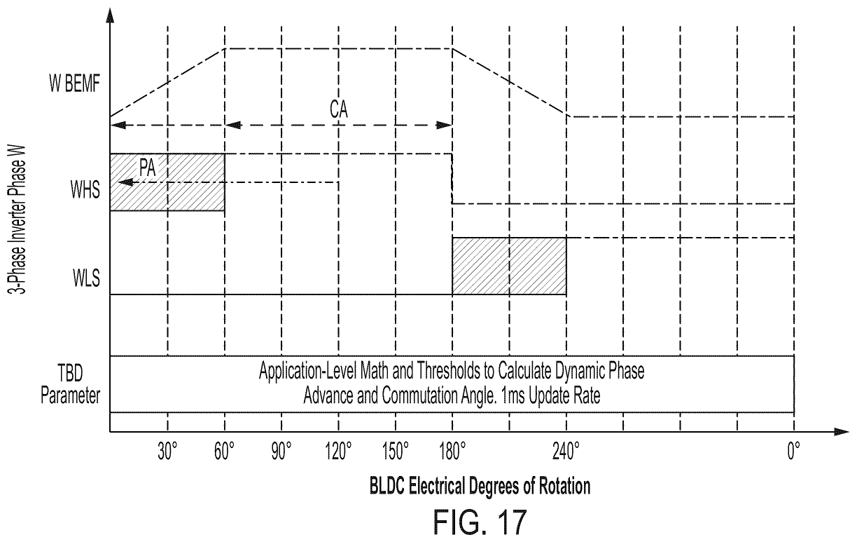

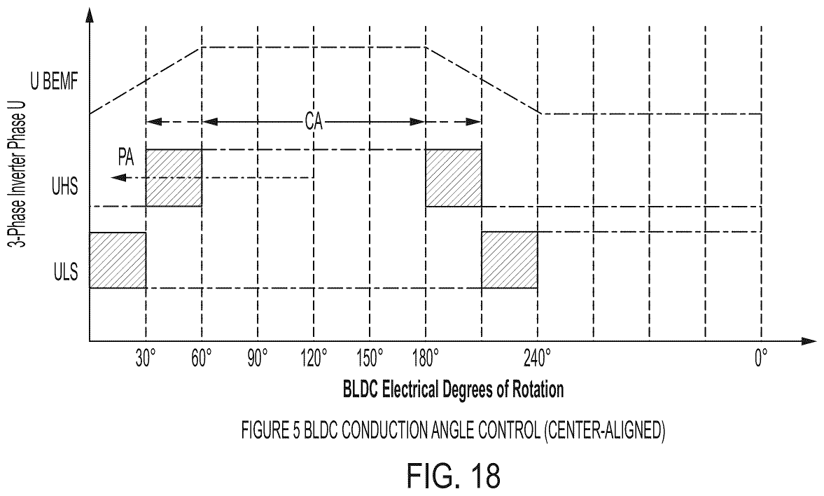

FIGS. 17 and 18 depict motor conduction angle controls for right aligned and center aligned configurations, respectively. FIG. 17 shows the gate pulses of a single motor phase plotted against the respective back-EMF waveform. In the traditional block commutation, the gate pulses are limited to just the solid pulses while in the conduction angle control scheme, the hatched phase advance parts get added to the solid pulses extending the overall pulse widths of the gates. It is worth noting at this point that the pulses were chosen to be extended in a “right-aligned” fashion (FIG. 17) instead of “center-aligned” (FIG. 18).

Although the disclosure has been described in detail with reference to certain preferred embodiments, variations and modifications exist within the scope and spirit of one or more independent aspects of the disclosure as described. Various features and advantages are set forth in the following claims.

1. A power tool comprising:
a brushless direct current (“BLDC”) motor;
a switching module including a plurality of high-side switches and a plurality of low-side switches, the switching module configured to drive the BLDC motor;
a plurality of rotor position sensors configured to output signals related to a position of a rotor of the BLDC motor; and
a controller configured to:
drive the motor using a twelve-step commutation sequence, a first step of the twelve-step commutation sequence including one of the plurality of high-side switches and one of the plurality of low-side switches turned to an ON conduction state,
receive the output signals from the plurality of rotor position sensors,
calculate an updated phase transition angle for the twelve-step commutation sequence based on the output signals, and
drive the motor using the twelve-step commutation sequence based on the updated phase transition angle, a second step of the twelve-step commutation sequence following a phase transition including either two of the plurality of high-side switches or two of the plurality of low-side switches turned to the ON conduction state.

2. The power tool of claim 1, wherein the switching module includes three high-side switches and three low-side switches.

3. The power tool of claim 1, wherein the controller is further configured to calculate a second updated phase transition angle for the twelve-step commutation sequence based on the output signals.

4. The power tool of claim 3, wherein the controller is further configured to drive the motor using the twelve-step commutation sequence based on the second updated phase transition angle.

5. The power tool of claim 4, wherein a third step of the twelve-step commutation sequence following a second phase transition including one of the plurality of high-side switches and one of the plurality of low-side switches turned to the ON conduction state.

6. The power tool of claim 5, wherein the controller is further configured to calculate a third updated phase transition angle for the twelve-step commutation sequence based on the output signals.

7. The power tool of claim 6, wherein the controller is further configured to drive the motor using the twelve-step commutation sequence based on the third updated phase transition angle.

8. The power tool of claim 1, wherein the controller is further configured to calculate a delay variable based on the updated phase transition angle.

9. The power tool of claim 8, wherein the controller is further configured to set the delay variable in response to driving the motor using the twelve-step commutation sequence based on the updated phase transition angle.

10. A power tool comprising:
a brushless direct current (“BLDC”) motor;
a multi-level switching module including a first set of switches and a second set of switches, each of the first set of switches and the second set of switches including a plurality of high-side switches and a plurality of low-side switches, the switching module configured to drive the BLDC motor;
a plurality of rotor position sensors configured to output signals related to a position of a rotor of the BLDC motor; and
a controller configured to:
drive the motor using a twelve-step commutation sequence, a first step of the twelve-step commutation sequence including each of the plurality of high-side switches in the first set of switches turned to an ON conduction state,
receive the output signals from the plurality of rotor position sensors,
calculate an updated phase transition angle for the twelve-step commutation sequence based on the output signals, and
drive the motor using the twelve-step commutation sequence based on the updated phase transition angle, a second step of the twelve-step commutation sequence following a phase transition including each of the plurality of high-side switches in the first set of switches turned to an ON conduction state and at least one of the plurality of high-side switches in the second set of switches turned to an ON conduction state.

11. The power tool of claim 10, wherein the multi-level switching module is a flying capacitor multi-level (“FCML”) inverter.

12. The power tool of claim 11, wherein the FCML inverter is a three-level FCML inverter.

13. The power tool of claim 10, wherein the controller is further configured to calculate a second updated phase transition angle for the twelve-step commutation sequence based on the output signals.

14. The power tool of claim 13, wherein the controller is further configured to drive the motor using the twelve-step commutation sequence based on the second updated phase transition angle.

15. The power tool of claim 10, wherein the controller is further configured to calculate a delay variable based on the updated phase transition angle.

16. The power tool of claim 15, wherein the controller is further configured to set the delay variable in response to driving the motor using the twelve-step commutation sequence based on the updated phase transition angle.

17. A method of controlling a power tool including a controller, the method comprising:
driving a motor using a twelve-step commutation sequence, a first step of the twelve-step commutation sequence including one of a plurality of high-side switches and one of a plurality of low-side switches turned to an ON conduction state;
receiving output signals from a plurality of rotor position sensors;
calculating an updated phase transition angle for the twelve-step commutation sequence based on the output signals; and
driving the motor using the twelve-step commutation sequence based on the updated phase transition angle, a second step of the twelve-step commutation sequence following a phase transition including either two of the plurality of high-side switches or two of the plurality of low-side switches turned to the ON conduction state.

18. The method of claim 17, further comprising:
calculating a second updated phase transition angle for the twelve-step commutation sequence based on the output signals.

19. The method of claim 18, further comprising:
driving the motor using the twelve-step commutation sequence based on the second updated phase transition angle.

20. The method of claim 17, further comprising:
calculating a delay variable based on the updated phase transition angle; and
setting the delay variable in response to driving the motor using the twelve-step commutation sequence based on the updated phase transition angle.

21-27. (canceled)
